(19) United States
(12) Patent Application Publication
(10) Pub. No.: US 2025/0199263 A1
(43) Pub. Date: Jun. 19, 2025

(54) CAMERA MODULE

(71) Applicant: SAMSUNG ELECTRO-MECHANICS CO., LTD., Suwon-si (KR)

(72) Inventor: Jongwon SONG, Suwon-si (KR)

(73) Assignee: SAMSUNG ELECTRO-MECHANICS CO., LTD., Suwon-si (KR)

(21) Appl. No.: 18/896,060

(22) Filed: Sep. 25, 2024

(30) Foreign Application Priority Data
Dec. 18, 2023 (KR) 10-2023-0184775

(51) Int. Cl. G02B 7/02; B60R 11/04; G02B 27/00; G03B 17/55

(52) U.S. Cl. CPC G02B 7/028; B60R 11/04; G02B 27/0006; G03B 17/55

(57) ABSTRACT

A camera module is provided. The camera module includes a lens barrel accommodating a lens, and having a first surface disposed along a circumference of the lens barrel and facing a direction parallel to an optical axis; a housing in which the lens barrel is disposed; an insulating member having a second surface facing the direction parallel to the optical axis, and disposed along the circumference of the lens barrel; and a heating member having a third surface and a fourth surface opposing each other. Each of the third surface and the fourth surface face the direction parallel to the optical axis, and the heating member is disposed on the insulating member along the circumference of the lens barrel. The third surface of the heating member faces the first surface of the lens barrel, and the fourth surface of the heating member faces the second surface of the insulating member.

### CROSS-REFERENCE TO RELATED APPLICATIONS

This application claims the benefit under 35 USC § 119 (a) of Korean Patent Application No. 10-2023-0184775 filed on Dec. 18, 2023, in the Korean Intellectual Property Office, the entire disclosure of which is incorporated herein by reference for all purposes.

### BACKGROUND

### 1. Field

The following description relates to a camera module.

### 2. Description of the Background t

An ultra-small camera module has been recently developed, and the ultra-small camera module may be widely implemented in miniature electronic products such as, but not limited to, smartphones, laptop computers, or game consoles.

The ultra-small camera may also be widely implemented in vehicles. For example, the vehicle may be equipped with a black box camera for vehicle protection or for the gathering of data related to traffic accidents, a rear surveillance camera that allows a vehicle driver to monitor a blind spot at the rear of the vehicle through a screen to ensure safety when reversing the vehicle, a perimeter detection camera that monitors the surroundings of the vehicle, or the like.

Due to a feature of the vehicle disposed outdoors, the indoor and outdoor temperatures of the vehicle may have various distributions based on a time of year. For example, the outdoor temperature may be higher than the indoor temperature in summer, and the temperature may drop to a subzero temperature in winter. Therefore, condensation including frost may occur in a component including the lens and glass of the camera due to a rapid temperature change. As a result, satisfactory images may not be acquired or product failure may occur.

As autonomous driving technology becomes sophisticated, there is an increasing need to secure a clear image by removing the frost from the camera lens in subzero weather. To remove the frost from a lens surface, heating using a heater may be typically used. However, when the heater is mounted on the camera module, it may be difficult for the camera module to have a smaller size, and high power consumption may be needed to remove the frost from the lens based on its structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens barrel which accommodates a lens, and which has a first surface disposed along a circumference of the lens barrel and faces a direction parallel to an optical axis; a housing in which the lens barrel is disposed; an insulating member which has a second surface that faces the direction parallel to the optical axis, and disposed along the circumference of the lens barrel; and a heating member which has a third surface and a fourth surface that oppose each other, and each of the third surface and the fourth surface face the direction parallel to the optical axis, and the heating member is disposed on the insulating member along the circumference of the lens barrel, wherein the third surface of the heating member faces the first surface of the lens barrel, and the fourth surface of the heating member faces the second surface of the insulating member.

The heating member may be in a form of a film.

The heating member may include a single layer.

The lens barrel may be inserted into the heating member.

The heating member may be disposed to surround the lens barrel.

The lens barrel may be inserted into the insulating member.

The insulating member may be disposed to surround the lens barrel.

The camera module may further include a board disposed in the housing; and a connecting member configured to electrically connect the heating member and the board to each other.

The lens barrel, the heating member, the insulating member, and the housing may be sequentially disposed in the optical axis direction.

The first surface may extend in a direction perpendicular to the optical axis.

The second surface may extend in a direction perpendicular to the optical axis.

The first surface of the lens barrel may be in contact with the heating member.

The second surface of the insulating member may be in contact with the heating member.

The insulating member may be disposed on the housing, and at least a portion of the insulating member is exposed outside the housing.

The insulating member may have a shape corresponding to a shape of the heating member.

The heating member may extend in a direction perpendicular to the optical axis.

The first surface of the lens barrel may be a stepped surface.

Other features and aspects will be apparent from the following detailed description, the drawings, and the claims.

### BRIEF DESCRIPTION OF DRAWINGS

FIG. 1 illustrates is a perspective view of an example camera module, in accordance with one or more embodiments.

FIG. 2 illustrates an exploded perspective view of the example camera module, in accordance with one or more embodiments.

FIG. 3 illustrates a partially exploded cross-sectional view of an example camera module, in accordance with one or more embodiments.

FIG. 4 illustrates a cross-sectional view showing a partial configuration of an example camera module, in accordance with one or more embodiments.

FIG. 5 illustrates a temperature distribution of an example camera module of a comparative example.

FIG. 6 illustrates a temperature distribution of an example camera module, in accordance with one or more embodiments.

FIG. 7 illustrates a process of removing frost from an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In addition, throughout the disclosure, an expression “on the plane” may indicate an example where a target is viewed from the top, and an expression “on the cross-section” may indicate an example where a cross-section of a target taken along a vertical direction is viewed from its side.

An “optical axis direction” disclosed herein is defined as the optical axis direction of a lens module. In an example, the “Optical axis direction” may correspond to a “vertical direction”, a “z-axis direction”, or the like.

One or more examples may provide a camera module in which a heat loss from a heating member is minimized, a heating efficiency of a lens barrel is increased, and frost is efficiently removed from the lens barrel.

One or more examples may provide a camera module in which power consumption of a heating member is reduced and which has a smaller size.

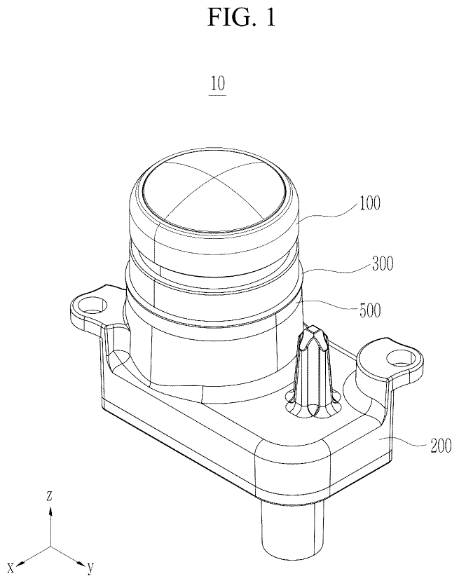

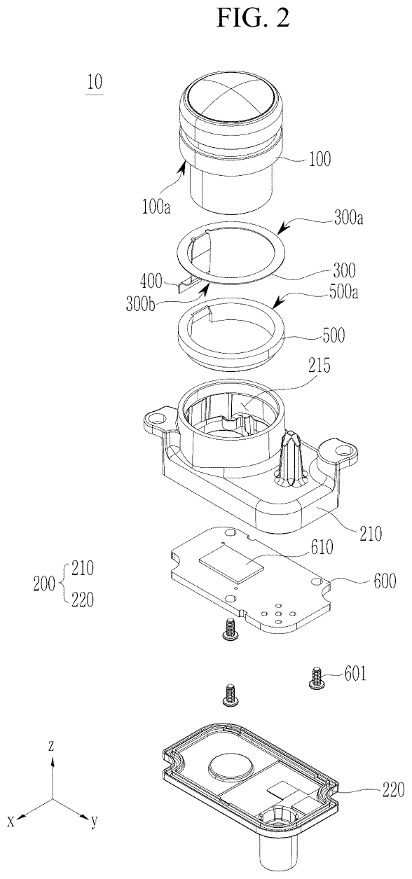

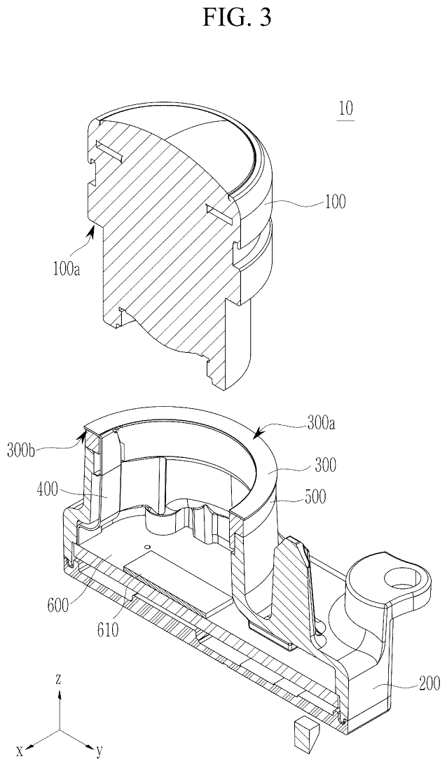

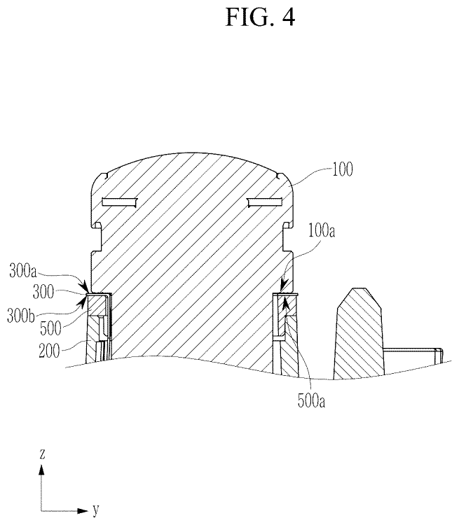

FIG. 1 illustrates a perspective view of an example camera module, in accordance with one or more embodiments; FIG. 2 illustrates an exploded perspective view of the example camera module, in accordance with one or more embodiments; FIG. 3 illustrates a partially exploded cross-sectional view of an example camera module, in accordance with one or more embodiments; and FIG. 4 illustrates a cross-sectional view showing a partial configuration of an example camera module, in accordance with one or more embodiments.

Referring to FIGS. 1 to 4, an example camera module 10, in accordance with one or more embodiments, may include a lens barrel 100, a housing 200, a heating member 300, a connecting member 400, an insulating member 500, a board 600, and an image sensor 610. However, the camera module 10 may be implemented by excluding some of these components, and may not exclude additional configurations other than these components.

The camera module 10 may include the lens barrel 100. The lens barrel 100 may be disposed at the housing 200. At least a portion of the lens barrel 100 may be accommodated in the housing 200. At least a portion of the lens barrel 100 may be inserted into an opening 215 of the housing 200 to be disposed on the front or upper side of the housing 200.

The lens barrel 100 may have a first surface 100a disposed along a circumference of the lens barrel 100 and facing a direction parallel to an optical axis. The first surface 100a may extend in a direction perpendicular to the optical axis. The first surface 100a may include a plane perpendicular to the optical axis.

The first surface 100a of the lens barrel 100 may be a stepped surface. In other words, a portion of the lens barrel 100 that is disposed above the first surface 100a and a portion of the lens barrel 100 that is disposed below the first surface 100a, in the optical axis direction, may have different widths in the direction perpendicular to the optical axis. Specifically, for the upper and lower portions of the lens barrel 100 in the optical axis direction based on the first surface 100a, the upper portion of the lens barrel 100 may have a width that is greater than a width of the lower portion of the lens barrel 100 in the direction perpendicular to the optical axis. The first surface 100a may be supported by the housing 200.

As an example, the lens barrel 100 may be screwed to an inner peripheral surface of the housing 200. In an example, the lens barrel 100 may have a screw thread formed on its outer peripheral surface that corresponds to a screw thread formed on the inner peripheral surface of the housing 200.

The lens barrel 100 may accommodate at least one lens. Each lens of the lens barrel 100 may be made of a synthetic resin material, a glass material, or a quartz material, as only example, and is not limited thereto, and may be made of various materials.

The camera module 10 may include the housing 200. The housing 200 may form an appearance of the camera module 10. The lens barrel 100, the board 600, and the connecting member 400 may be disposed in the housing 200. In an example, the insulating member 500 may be disposed in the housing 200.

The housing 200 may include the upper housing 210 and the lower housing 220. The upper housing 210 may be disposed on the lower housing 220. In an example, the upper housing 210 may be formed integrally with the lower housing 220. The upper housing 210 may include the opening 215. The lens barrel 100 may be disposed in the opening 215 of the upper housing 200. An inner surface of the upper housing 210 may be spaced apart from an outer surface of the lens barrel 100 by a predetermined distance. At least a portion of the connecting member 400 may be disposed in a space between the inner surface of the upper housing 210 and the outer surface of the lens barrel 100.

The lower housing 220 may be disposed below the upper housing 210. The lower housing 220 may be coupled to the upper housing 210. In an example, the lower housing 220 may be formed integrally with the upper housing 210.

The camera module 10, in accordance with one or more embodiments, may include the insulating member 500. The insulating member 500 may be disposed on one surface of the heating member 300. The insulating member 500 may be disposed on the housing 200 for at least a portion of the insulating member 500 to be exposed outside the housing 200. The insulating member 500 may be disposed between the heating member 300 and an outer surface of the housing 200. Through this configuration, it is possible to prevent heat generated by the heating member 300 from being lost through the housing 200. That is, it is possible to improve efficiency of transferring heat generated by the heating member 300 to the lens barrel 100.

The insulating member 500 may be disposed along the circumference of the lens barrel 100. The insulating member 500 may be disposed to surround the lens barrel 100. The insulating member 500 may extend outward from the outer peripheral surface of the lens barrel 100. The insulating member 500 may have a shape corresponding to a shape of the heating member 300. Accordingly, a contact area between the insulating member 500 and the heating member 300 may be increased to minimize the transfer of heat emitted by the heating member 300 to the housing 200, thus increasing heating efficiency of the lens barrel 100 and effectively removing frost.

The insulating member 500 may have a second surface 500a facing the direction parallel to the optical axis. The lens barrel 100 may be inserted into the insulating member 500. The insulating member 500 may extend in the direction perpendicular to the optical axis. The second surface 500a may extend in the direction perpendicular to the optical axis. The second surface 500a may include the plane perpendicular to the optical axis.

In an example, the insulating member 500 may have a ring shape. The insulating member 500 may have an “O” shape or a donut shape. The insulating member 500 may have a closed-loop shape.

Referring to FIGS. 1 to 4, the insulating member 500 is described as having the “O” shape as an example, is not limited thereto, and may have any shape as long as the insulating member 500 has an opening part disposed therein to allow the lens barrel 100 to be inserted thereto.

The insulating member 500 may be made of, as non-limited examples, a ceramic material, a plastic material, a silicon-based material, or the like. However, these materials are only examples. The material of the insulating member 500 is not limited thereto, and may be changed in various ways as long as the material of the insulating member 500 is a material having a low heat transfer coefficient, and is capable of increasing heat transfer efficiency to the lens barrel 100 by reducing a heat loss to the housing 200.

The camera module 10 according to an embodiment may include the heating member 300. The heating member 300 may be disposed on the housing. The heating member 300 may be disposed adjacent to an outer upper surface of the housing 200. The heating member 300 may include the opening part 215.

The heating member 300 may be disposed on the insulating member 500. The heating member 300 may be disposed along the circumference of the lens barrel 100. The heating member 300 may be disposed to surround the lens barrel 100. The lens barrel 100, the heating member 300, the insulating member 500, and the housing 200 (210, 220) may be sequentially disposed in the optical axis direction. The heating member 300 may extend outward from the outer peripheral surface of the lens barrel 100. The heating member 300 may have a shape corresponding to a shape of the insulating member 500.

The heating member 300 may have a third surface 300a and a fourth surface 300b opposing each other and each facing the direction parallel to the optical axis. The third surface 300a and the fourth surface 300b may oppose each other in the optical axis direction. The lens barrel 100 may be inserted into the heating member 300. The heating member 300 may extend in the direction perpendicular to the optical axis. The third surface 300a may extend in the direction perpendicular to the optical axis. The third surface 300a may include the plane perpendicular to the optical axis. The fourth surface 300b may extend in the direction perpendicular to the optical axis. The fourth surface 300b may include the plane perpendicular to the optical axis.

The third surface 300a of the heating member 300 may face the first surface 100a of the lens barrel 100. The heating member 300 may be in contact with the first surface 100a of the lens barrel 100. The fourth surface 300b of the heating member 300 may face the second surface 500a of the insulating member 500. The fourth surface 300b of the heating member 300 may be in contact with the second surface 500a of the insulating member 500.

In a non-limited example, the heating member 300 may be attached to one surface of the lens barrel 100 by using, as only an example, an adhesive member (not shown). The heating member 300 may be attached to the first surface 100a of the lens barrel 100 by using the adhesive member. The adhesive member may have a shape corresponding to the shape of the first surface 100a. The adhesive member may have a shape corresponding to a shape of the heating member 300. As an example, the adhesive member may have a ring shape.

In an example, the heating member 300 may be in the form of a film. A type of the heating member 300 may be a carbon nanotube (CNT), a constant wattage (CW), or a positive temperature coefficient heater (PTC). In an example, the heating member 300 may include a single layer. Therefore, the camera module 10 may have a smaller size. When the heating member 300 is in the form of the film having a single layer structure, the third surface 300a and the fourth surface 300b may each be the upper and lower surfaces of the film.

The heating member 300 may be electrically connected to the connecting member 400. The heating member 300 may have the ring shape. The heating member 300 may have the “O” shape or the donut shape. The heating member 300 may have the closed-loop shape. The heating member 300 may include a heating wire having the closed-loop shape. Through this configuration, when supplied with a current, the heating member 300 may emit more heat than the connecting member 400. That is, when supplied with the current through the connecting member 400, the heating member 300 may generate heat to thus remove moisture from the lens barrel 100.

Referring to FIGS. 1 to 4, the heating member 300 is described as having the “O” shape as an example, but is not limited thereto, and may have any shape as long as the heating member 300 has the opening part 215 disposed therein to allow the lens barrel 100 to be inserted thereto.

The heating member 300 may emit heat by receiving the current from the board 600. As a non-limited example, the heating member 300 may be a transparent heating film coated with conductive indium thin oxide (ITO) which may generate heat based on its own resistance component. The heating member 300 may be formed, as an example, by the coating process or deposition process of an indium tin oxide material. However, the material of the heating member 300 is an example, is not limited thereto, and may be changed in various ways as long as the material of the heating member 300 is a material which may generate heat by being supplied with the current.

The camera module 10 may include the connecting member 400. The connecting member 400 may be coupled to the board 600. The connecting member 400 may be electrically connected to the board 600. The connecting member 400 may be connected to a power source disposed on the board 600. The connecting member 400 may be connected to the heating member 300. The connecting member 400 may be coupled with the heating member 300. The connecting member 400 may electrically connect the heating member 300 and the board 600 to each other. The connecting member 400 may have a bent portion.

The camera module 10 may include the board 600. In an example, the board 600 may be disposed in the housing 200. The board 600 may be disposed inside the housing 200. In an example, the board 600 may be disposed below the lens barrel 100. The board 600 may include a printed circuit board (PCB) or a flexible printed circuit board (FPCB), as examples. The board 600 may be coupled with the connecting member 400. The board 600 may be electrically connected to the connecting member 400. The image sensor 610 may be mounted on the board 600. The board 600 may be electrically connected to the image sensor 610.

The board 600 may be fixed to the housing 200 through a fixing member 601. In an example, the fixing member 601 may be plural in number. The fixing member 601 may pass through the board 600. In an example, the fixing member 601 may be in the form of a screw, but is not limited thereto, and may be of any shape in which the fixing member 601 may fix the board.

The camera module 10 may include the image sensor 610. The image sensor 610 may be disposed in the housing 200. In an example, the image sensor 610 may be disposed on the board 600. The image sensor 610 may be electrically connected to the board 600. The image sensor 610 may be disposed on the front surface or upper surface of the board 600. In an example, the image sensor 610 may be coupled to the board 600 by surface mounting technology (SMT). In another example, the image sensor 610 may be coupled to the board 600 by flip chip technology. The optical axis of the image sensor 610 may be aligned with the optical axis of the lens barrel 100.

The camera module 10 may include a connector (not shown). The connector may be disposed in the housing 200. The connector may be coupled to the board 600. The connector may pass through the housing 200 to thus be coupled to the board 600. The connector may be electrically connected to the board 600. The connector may supply external power to the camera module 10. A cross section of the connector may be formed in a circular shape. Alternatively, the cross section of the connector may be variously changed, such as an elliptical or square shape. The camera module 10 according to an example embodiment may also include the connector. As an example, an O-ring may be disposed in a space between the connector and the housing 200 to thus seal the space between the connector and the housing 200.

Referring to FIGS. 1 to 4, the heating member 300 and the insulating member 500 are described as being disposed outside the housing 200, but are not limited thereto. The heating member 300 and the insulating member 500 may also be disposed inside the housing 200. In an example, the insulating member 500 may be inserted into the housing 200 through the opening part of the housing 200. The insulating member 500 may be disposed in the housing 200. The heating member 300 may be inserted into the housing 200 through the opening part of the housing 200. The heating member 300 may be disposed in the housing 200.

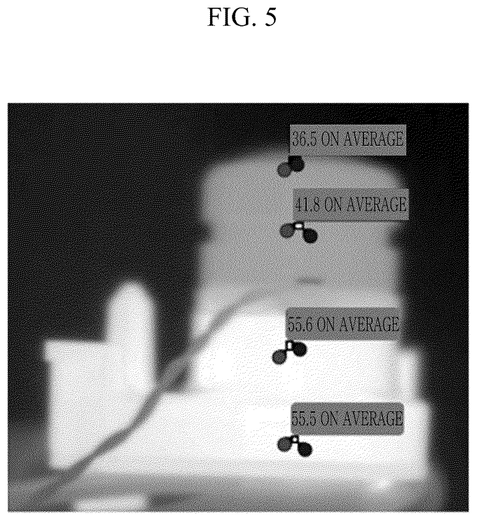

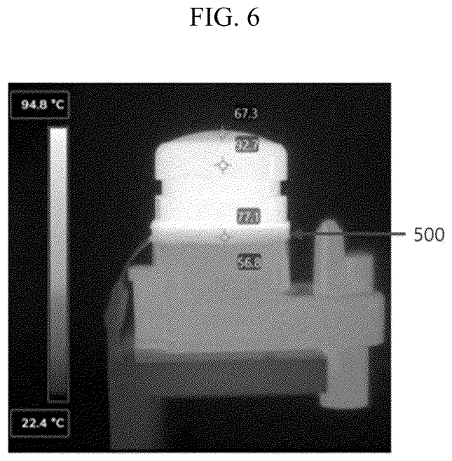

FIG. 5 illustrates a temperature distribution of an example camera module of a comparative example; and FIG. 6 illustrates a temperature distribution of the camera module, in accordance with one or more embodiments.

FIG. 5 illustrates the temperature distribution of the example camera module when the heating member generates heat in the camera module of the comparative example that does not include the insulating member.

Referring to FIG. 5, it may be seen that in the camera module of the comparative example, heat generated by the heating member is transferred to the housing, and a temperature of the housing is higher than a temperature of the lens barrel. Specifically, it may be seen that a temperature of the upper housing is 55.6° C. on average, and a temperature of the lower housing 200 is 55.5° C. In comparison, it may be seen that the temperature of the lens barrel is 41.8° C. and 36.5° C. on average. Therefore, the heating member may have lower heat generation efficiency of removing frost from the lens barrel, and high heat generation and power consumption may be desired to increase the temperature of the lens barrel.

FIG. 6 illustrates the temperature distribution of the example camera module 10 when the heating member generates heat in the camera module 10 including the insulating member, in accordance with one or more embodiments.

Referring to FIG. 6, it may be seen that in the camera module, in accordance with one or more embodiments, an amount of heat generated by the heating member 300 that is transferred to the housing 200 is reduced, and the temperature of the lens barrel 100 is thus higher than in the camera module of the comparative example. Specifically, it may be seen that the temperature of the lens barrel 100 is distributed at 77.1° C., 92.7° C., or 67.3° C. based on its position. In comparison, it may be seen that the heat loss to the housing 200 is reduced and the temperature of the housing is about 55.6° C. Therefore, it may be seen that the insulating member 500 is disposed between the heating member 300 and the housing 200, and the lens barrel 100 and the insulating member 500 have their surfaces each facing the heating member 300, thus minimizing the heat loss to the housing and improving the heat transfer efficiency to the lens barrel.

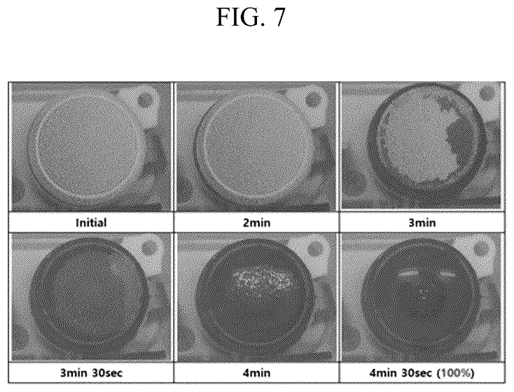

FIG. 7 illustrates a process of removing frost from the camera module, in accordance with one or more embodiments.

FIG. 7 illustrates that frost is removed over time from an upper surface of the lens barrel 100 included in the camera module 10, in accordance with one or more embodiments, when the heating member 300 generates heat under conditions of an environmental temperature of −30° C. and power consumption of 3 W.

Referring to FIG. 7, it may be seen that frost initially covers the upper surface of the lens barrel 100, and the frost gradually disappears over time, and is completely removed after about 4 minutes and 30 seconds. In other words, it may be seen that frost may be effectively removed even under a low power consumption condition by increasing heat generation efficiency of the lens barrel.

According to the camera module 10 according to the above-described embodiment, the insulating member 500 may be disposed between the housing 200 and the heating member 300 to insulate a portion of the housing 200 that does not desire the heat transfer, thereby minimizing the heat loss from the heating member 300, increasing the heating efficiency of the lens barrel 100 that desires the heat transfer, and effectively removing frost from the lens barrel 100. Additionally, the camera module 10 may increase the heat generation and the heat transfer efficiency to thus reduce the power consumption of the heating member 300, and supply the power to the heating member 300 through the power of the camera module 10, thereby allowing the camera module 10 to have a smaller size. Additionally, the camera module 10 may include the heating member 300 mounted therein, thereby ensuring reliability of an operation of the heating member 300.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a lens barrel which accommodates a lens, and which has a first surface disposed along a circumference of the lens barrel and faces a direction parallel to an optical axis;
a housing in which the lens barrel is disposed;
an insulating member which has a second surface that faces the direction parallel to the optical axis, and disposed along the circumference of the lens barrel; and
a heating member which has a third surface and a fourth surface that oppose each other, and each of the third surface and the fourth surface face the direction parallel to the optical axis, and the heating member is disposed on the insulating member along the circumference of the lens barrel,
wherein the third surface of the heating member faces the first surface of the lens barrel, and
the fourth surface of the heating member faces the second surface of the insulating member.

2. The camera module of claim 1, wherein the heating member is in a form of a film.

3. The camera module of claim 2, wherein the heating member comprises a single layer.

4. The camera module of claim 1, wherein the lens barrel is inserted into the heating member.

5. The camera module of claim 1, wherein the heating member is disposed to surround the lens barrel.

6. The camera module of claim 1, wherein the lens barrel is inserted into the insulating member.

7. The camera module of claim 1, wherein the insulating member is disposed to surround the lens barrel.

8. The camera module of claim 1, further comprising:
a board disposed in the housing; and
a connecting member configured to electrically connect the heating member and the board to each other.

9. The camera module of claim 1, wherein the lens barrel, the heating member, the insulating member, and the housing are sequentially disposed in the optical axis direction.

10. The camera module of claim 1, wherein the first surface extends in a direction perpendicular to the optical axis.

11. The camera module of claim 1, wherein the second surface extends in a direction perpendicular to the optical axis.

12. The camera module of claim 1, wherein the first surface of the lens barrel is in contact with the heating member.

13. The camera module of claim 1, wherein the second surface of the insulating member is in contact with the heating member.

14. The camera module of claim 1, wherein the insulating member is disposed on the housing, and at least a portion of the insulating member is exposed outside the housing.

15. The camera module of claim 1, wherein the insulating member has a shape corresponding to a shape of the heating member.

16. The camera module of claim 1, wherein the heating member extends in a direction perpendicular to the optical axis.

17. The camera module of claim 1, wherein the first surface of the lens barrel is a stepped surface.
